(19) United States
(12) Patent Application Publication
(10) Pub. No.: US 2018/0004516 A1
(43) Pub. Date: Jan. 4, 2018

(54) ADMINISTERING INSTRUCTION TAGS IN A COMPUTER PROCESSOR

(71) Applicant: International Business Machines Corporation, Armonk, NY (US)

(72) Inventors: KURT A. FEISTE, AUSTIN, TX (US); HUNG Q. LE, AUSTIN, TX (US); DAVID S. LEVITAN, AUSTIN, TX (US); ALBERT J. VAN NORSTRAND, JR., ROUND ROCK, TX (US)

(21) Appl. No.: 15/200,153

(22) Filed: Jul. 1, 2016

(51) Int. Cl. G06F 9/30

(52) U.S. Cl. CPC G06F 9/30018; G06F 9/30043

(57) ABSTRACT

Administering ITAGs in a computer processor, includes, for each instruction in a single-thread mode: incrementing a value of a wrap around counter; setting a wrap bit to a predefined value if incrementing the value causes the counter to wrap around; generating, in dependence upon the counter value and the wrap bit, an ITAG for the instruction, the ITAG comprising a bit string having a wrap bit and an index comprising the counter value; and, for each instruction in a multi-thread mode: incrementing the value of the wrap around counter; setting a wrap bit to a predefined value if incrementing the value causes the counter to wrap around; and generating, in dependence upon the counter value and the wrap bit, an ITAG for the instruction, the ITAG comprising a bit string having the wrap bit, a thread identifier, and an index comprising the counter value.

### BACKGROUND OF THE INVENTION

### Field of the Invention

The field of the invention is data processing, or, more specifically, methods and apparatus for administering instruction tags in a computer processor.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area of computer system technology that has advanced is computer processors. Instruction executed by a computer processor are in some cases identified by instruction tags (ITAGs). To that end, efficient administration of such ITAGs—the generation, structure, and use—may be a goal of processor designers.

### SUMMARY

Methods and apparatus for administering instruction tags (ITAGs) in a computer processor are disclosed in this specification. Such administration of ITAGs includes, for each instruction when the computer processor is in a single-thread mode of operation: incrementing a value of a wrap around counter; setting a wrap bit to a predefined value if incrementing the value of the wrap around counter causes the counter to wrap around; generating, in dependence upon the counter value and the wrap bit, an ITAG for the instruction, the ITAG comprising a bit string, the bit string comprising the wrap bit and an index, the index comprising the counter value; and, for each instruction when the computer processor is in a multi-thread mode of operation: incrementing the value of the wrap around counter; setting a wrap bit to a predefined value if incrementing the value of the wrap around counter causes the counter to wrap around; and generating, in dependence upon the counter value and the wrap bit, an ITAG for the instruction, the ITAG comprising a bit string, the bit string comprising the wrap bit, a thread identifier, and an index, the index comprising the counter value.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for administering ITAGs in a computer processor are disclosed in this specification according to embodiments of the present invention.

FIG. 2 sets forth a block diagram of a portion of a multi-slice processor according to embodiments of the present invention.

FIG. 3 sets forth a flow chart illustrating an exemplary method for administering ITAGs in a computer processor according to embodiments of the present invention.

FIG. 4 sets forth a flow chart illustrating an example method of determining whether a first ITAG is older than a second ITAG according to embodiments of the present invention.

FIG. 5 sets forth a flow chart illustrating another example method of administering ITAGs in a computer processor according to embodiments of the present invention.

### DETAILED DESCRIPTION OF EXEMPLARY EMBODIMENTS

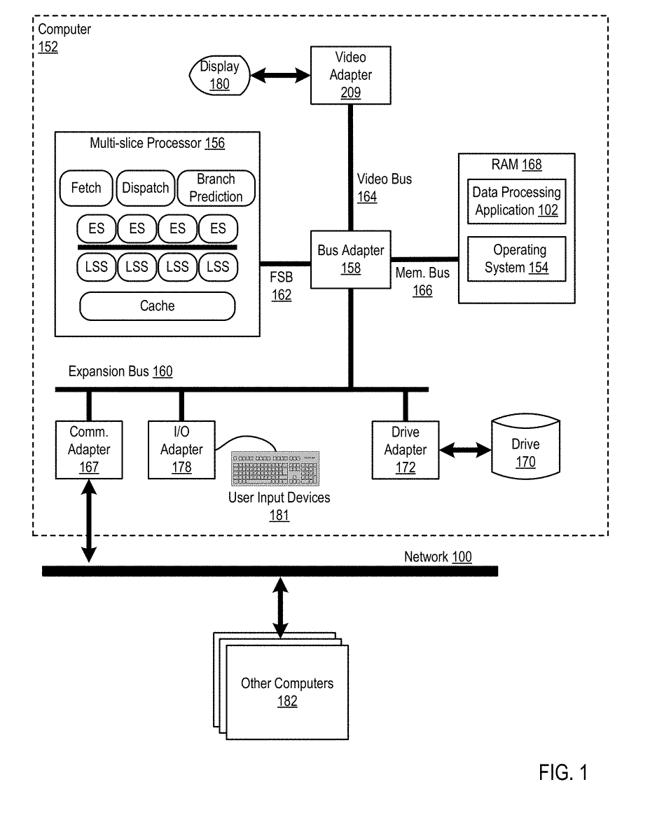

Exemplary methods and apparatus for administering ITAGs in a computer processor in accordance with the present invention are described with reference to the accompanying drawings, beginning with FIG. 1. FIG. 1 sets forth a block diagram of an example system configured for administering ITAGs in a computer processor according to embodiments of the present invention. The system of FIG. 1 includes an example of automated computing machinery in the form of a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The example computer processor (156) of FIG. 1 may be implemented as a multi-slice processor. The term ‘multi-slice’ as used in this specification refers to a processor having a plurality of similar or identical sets of components, where each set may operate independently of all the other sets or in concert with the one or more of the other sets. The multi-slice processor (156) of FIG. 1, for example, includes several execution slices (‘ES’) and several load/store slices (‘LSS’)—where load/store slices may generally be referred to as load/store units. Each execution slice may be configured to provide components that support execution of instructions: an issue queue, general purpose registers, a history buffer, an arithmetic logic unit (including a vector scalar unit, a floating point unit, and others), and the like. Each of the load/store slices may be configured with components that support data movement operations such as loading of data from cache or memory or storing data in cache or memory. In some embodiments, each of the load/store slices includes a data cache. The load/store slices are coupled to the execution slices through a results bus. In some embodiments, each execution slice may be associated with a single load/store slice to form a single processor slice. In some embodiments, multiple processor slices may be configured to operate together.

The example multi-slice processor (156) of FIG. 1 may also include, in addition to the execution and load/store slices, other processor components. In the system of FIG. 1, the multi-slice processor (156) includes fetch logic, dispatch logic, and branch prediction logic. Further, although in some embodiments each load/store slice includes cache memory, the multi-slice processor (156) may also include cache accessible by any or all of the processor slices.

Although the multi-slice processor (156) in the example of FIG. 1 is shown to be coupled to RAM (168) through a front side bus (162), a bus adapter (158) and a high speed memory bus (166), readers of skill in the art will recognize that such configuration is only an example implementation. In fact, the multi-slice processor (156) may be coupled to other components of a computer system in a variety of configurations. For example, the multi-slice processor (156) in some embodiments may include a memory controller configured for direct coupling to a memory bus (166). In some embodiments, the multi-slice processor (156) may support direct peripheral connections, such as PCIe connections and the like.

Stored in RAM (168) in the example computer (152) is a data processing application (102), a module of computer program instructions that when executed by the multi-slice processor (156) may provide any number of data processing tasks. Examples of such data processing applications may include a word processing application, a spreadsheet application, a database management application, a media library application, a web server application, and so on as will occur to readers of skill in the art. Also stored in RAM (168) is an operating system (154). Operating systems useful in computers configured for administering ITAGs in a computer processor according to embodiments of the present invention include UNIX™, Linux™ Microsoft Windows™, AIX™, IBM's z/OS™, and others as will occur to those of skill in the art. The operating system (154) and data processing application (102) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for administering ITAGs in a computer processor according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for administering ITAGs in a computer processor according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

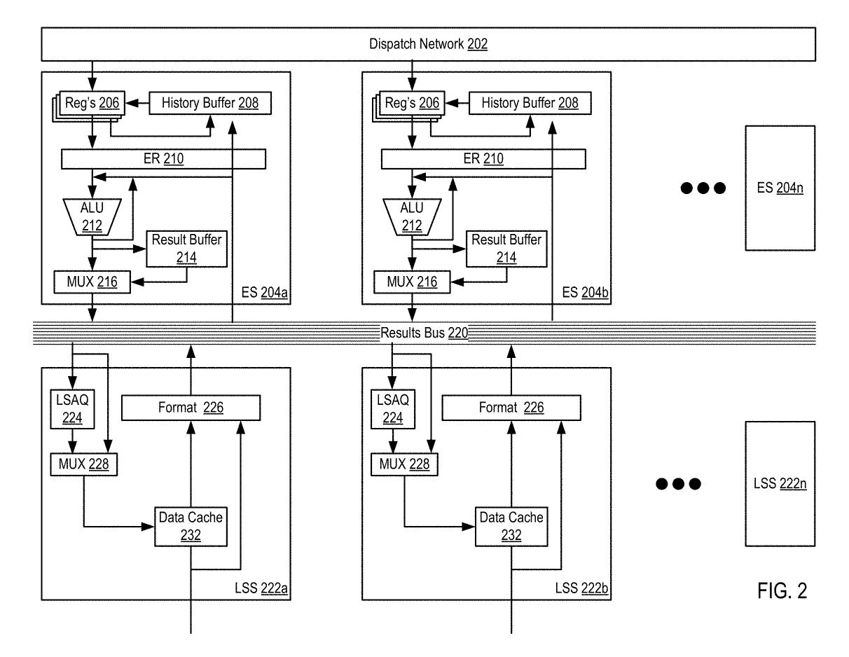

For further explanation, FIG. 2 sets forth a block diagram of a portion of a multi-slice processor according to embodiments of the present invention. The multi-slice processor in the example of FIG. 2 includes a dispatch network (202). The dispatch network (202) includes logic configured to dispatch instructions for execution among execution slices.

The multi-slice processor in the example of FIG. 2 also includes a number of execution slices (204a, 204b-204n). Each execution slice includes general purpose registers (206) and a history buffer (208). The general purpose registers and history buffer may sometimes be referred to as the mapping facility, as the registers are utilized for register renaming and support logical registers.

The general purpose registers (206) are configured to store the youngest instruction targeting a particular logical register and the result of the execution of the instruction. A logical register is an abstraction of a physical register that enables out-of-order execution of instructions that target the same physical register.

When a younger instruction targeting the same particular logical register is received, the entry in the general purpose register is moved to the history buffer, and the entry in the general purpose register is replaced by the younger instruction. The history buffer (208) may be configured to store many instructions targeting the same logical register. That is, the general purpose register is generally configured to store a single, youngest instruction for each logical register while the history buffer may store many, non-youngest instructions for each logical register.

Each execution slice (204) of the multi-slice processor of FIG. 2 also includes an execution reservation station (210). The execution reservation station (210) may be configured to issue instructions for execution. The execution reservation station (210) may include an issue queue. The issue queue may include an entry for each operand of an instruction. The execution reservation station may issue the operands for execution by an arithmetic logic unit or to a load/store slice (222a, 222b, 222c) via the results bus (220).

The arithmetic logic unit (212) depicted in the example of FIG. 2 may be composed of many components, such as add logic, multiply logic, floating point units, vector/scalar units, and so on. Once an arithmetic logic unit executes an operand, the result of the execution may be stored in the result buffer (214) or provided on the results bus (220) through a multiplexer (216).

The results bus (220) may be configured in a variety of manners and be of composed in a variety of sizes. In some instances, each execution slice may be configured to provide results on a single bus line of the results bus (220). In a similar manner, each load/store slice may be configured to provide results on a single bus line of the results bus (220). In such a configuration, a multi-slice processor with four processor slices may have a results bus with eight bus lines—four bus lines assigned to each of the four load/store slices and four bus lines assigned to each of the four execution slices. Each of the execution slices may be configured to snoop results on any of the bus lines of the results bus. In some embodiments, any instruction may be dispatched to a particular execution unit and then by issued to any other slice for performance. As such, any of the execution slices may be coupled to all of the bus lines to receive results from any other slice. Further, each load/store slice may be coupled to each bus line in order to receive an issue load/store instruction from any of the execution slices. Readers of skill in the art will recognize that many different configurations of the results bus may be implemented.

The multi-slice processor in the example of FIG. 2 also includes a number of load/store slices (222a, 222b-222n). Each load/store slice includes a queue (224), a multiplexer (228), a data cache (232), and formatting logic (226), among other components. The queue receives load and store operations to be carried out by the load/store slice (222). The formatting logic (226) formats data into a form that may be returned on the results bus (220) to an execution slice as a result of a load or store instruction.

The example multi-slice processor of FIG. 2 may be configured for flush and recovery operations. A flush and recovery operation is an operation in which the registers (general purpose register and history buffer) of the multi-slice processor are effectively ‘rolled back’ to a previous state. The term ‘restore’ and ‘recover’ may be used, as context requires in this specification, as synonyms. Flush and recovery operations may be carried out for many reasons, including missed branch predictions, exceptions, and the like. Consider, as an example of a typical flush and recovery operation, that a dispatcher of the multi-slice processor dispatches over time and in the following order: an instruction A targeting logical register 5, an instruction B targeting logical register 5, and an instruction C targeting logical register 5. At the time instruction A is dispatched, the instruction parameters are stored in the general purpose register entry for logical register 5. Then, when instruction B is dispatched, instruction A is evicted to the history buffer (all instruction parameters are copied to the history buffer, including the logical register and the identification of instruction B as the evictor of instruction A), and the parameters of instruction B are stored in the general purpose register entry for logical register 5. When instruction C is dispatched, instruction B is evicted to the history buffer and the parameters of instruction C are stored in the general purpose register entry for logical register 5. Consider, now, that a flush and recovery operation of the registers is issued in which the dispatch issues a flush identifier matching the identifier of instruction C. In such an example, flush and recovery includes discarding the parameters of instruction C in the general purpose register entry for logical register 5 and moving the parameters of instruction B from the history buffer for instruction B back into the entry of general purpose register for logical register 5.

During the flush and recovery operation, in prior art processors, the dispatcher was configured to halt dispatch of new instructions to an execution slice. Such instructions may be considered either target or source instructions. A target instruction is an instruction that targets a logical register for storage of result data. A source instruction by contrast has, as its source, a logical register. A target instruction, when executed, will result in data stored in an entry of a register file while a source instruction utilizes such data as a source for executing the instruction. A source instruction, while utilizing one logical register as its source, may also target another logical register for storage of the results of instruction. That is, with respect to one logical register, an instruction may be considered a source instruction and with respect to another logical register, the same instruction may be considered a target instruction.

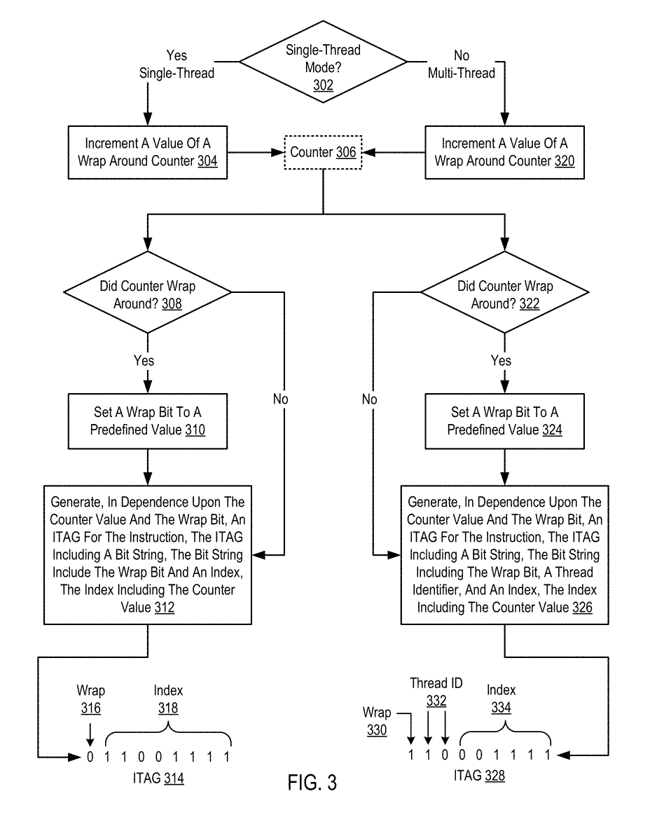

For further explanation, FIG. 3 sets forth a flow chart illustrating an exemplary method for administering ITAGs in a computer processor according to embodiments of the present invention. The method of FIG. 3 includes determining (302) whether the computer processor is configured in a single-thread mode of operation. Such a determination may be carried out by inspecting contents of a register of the processor configured to maintain a value that indicates the current mode of operation. Readers will understand that a processor, such as the multi-slice processor of FIG. 2 may be configured to operate in various modes of operation. In a single thread mode, for example, multiple components (such as the multiple execution and load/store slices in the multi-slice processor of FIG. 2) may be configured to execute instructions of a single thread. In a dual-thread mode of operation, the components of the processor may be divided such that half are dedicated to execution of a first thread and the remaining half are dedicated to execution of a second thread. Memory structures within the processor may likewise be divided between threads in a multi-threaded mode of operation.

For each instruction when the computer processor is in a single-thread mode of operation, the method of FIG. 3 continues by incrementing (304) a value of a wrap around counter (306). A wrap-around counter is a counter that has a maximum value that when reaches, begins at its initial value. For example, such a wrap around counter may have an initial value of 0 and a maximum value of 255. When incremented 256 times, the counter's value ‘wraps around’ back to 0.

The method of FIG. 3 continues by determining (308) whether the wrap around counter in fact wrapped around after the incrementation (304). If the wrap around counter wrapped around, the method of FIG. 3 continues by setting (310) a wrap bit to a predefined value. A wrap bit as the term is used here refers to a single bit that is included in each ITAG. The value of the wrap bit is determined based on the counter wrapping around. In some examples, the value of the wrap bit is 0 until the counter wraps around and then the value of the wrap bit is 1. The wrap bit, as explained below in greater detail with respect to enables efficient comparison of ITAGs for the purpose of determining the relative age of the compared ITAGs.

The method of FIG. 3 continues by generating (312), in dependence upon the counter value and the wrap bit, an ITAG for the instruction. Generating (312) the ITAG may be carried out by encoding a bit string that includes the present value of the wrap bit and, as an ‘index’, the present value of the counter (306). That is, the ITAG comprises a bit string, where the bit string includes the wrap bit and an index, and the index comprises the counter value. In some embodiments, the first bit (reading left-to-right) of the bit string is the wrap bit, followed by the index. An ITAG (314) for an instruction when the processor is configured in a single-thread mode of operation is depicted as an example in the method of FIG. 3. The ITAG includes a wrap bit (316) with a value of 0 indicating that the counter did not wrap around at the previous increment and an index (318) comprising 8 bits having a value of the counter (306).

In a single thread mode, there is no need for identifier of thread to be encoded in the ITAG. In multi-thread modes, however, each ITAG represents an instruction that belongs to a particular thread. Thus, each ITAGs may be configured to identify the thread to which the instruction belongs.

To that end, if the processor is not in a single-thread mode of operation, a similar method of administering an ITAG is carried out. That is, for instructions when the computer processor is configured in a multi-thread mode of operation, the method of FIG. 3 includes incrementing (320) the value of the wrap around counter (306); determining (322) whether the counter wrapped around, and if the counter wrapped around setting (324) a wrap bit to a predefined value.

The method of FIG. 3 also includes generating (326), in dependence upon the counter value and the wrap bit, an ITAG for the instruction. In the method of FIG. 3, generating (326) an ITAG for an instruction in a multi-thread mode includes creating a bit string comprising a wrap bit (330), an index (334) that comprises the present counter value (306), and a thread identifier (334). In the example of FIG. 3, an ITAG (328) is depicted for an instruction when the computer processor is in a multi-thread mode of operation. The ITAG (328) includes a wrap bit (330) having a value of 1 indicating that the counter wrapped around on a previous increment. The ITAG (328) also includes a thread identifier consisting of two bits which is capable of identifying up to four independent threads. The ITAG (328) also includes an index (334) consisting of 6 bits representing the present counter value.

Readers will understand that this example ITAGs (314, 328) depicted in the example of FIG. 3 are but a few of many possible example configurations of an ITAG. In some embodiments, the computer processor is in a single-thread mode of operation and the ITAG comprises a 9-bit long bit string, where a first bit comprises the wrap bit and the other 8 bits comprise the index. In some embodiments, the computer processor is in a dual-thread mode of operation and the ITAG comprises a 9-bit long bit string, where a first bit comprises the wrap bit, a second bit comprises a thread identifier, and the other 7 bits comprise the index. In some embodiments, the computer processor is in a quad-thread mode of operation and the ITAG comprises a 9-bit long bit string, where a first bit comprises the wrap bit, a second and third bits comprise a thread identifier, and the other 6 bits comprise the index.

Readers of skill in the art will also recognize that ITAGs may be utilized as index into various tables and other data structures present in the computer processor architecture. In one example, an ICT (instruction completion table) may be indexed by the second through ninth bits of the ITAG (all bits except the wrap bit). This may be true regardless of whether the computer processor is configured for a single or a multi-threaded mode of operation. The ICT may be divided based on the current thread of operation. In a single thread mode, there is no division and 256 entries (in an example in which the maximum number of ITAGs is 256). In a dual thread mode, the ICT may be divided in two in which records 0-127 are designated to a first thread and 128-255 are designated for a second thread. In a quad-thread mode, the ICT may be divided into four parts, where records 0-63 are designated for a first thread, records 64-127 are designated for a second thread, records 128-191 are designated to a third thread and records 192-255 are designated to a fourth thread. In this configuration, the processor begins assigning ITAG values as follows: the first ITAG for the thread₀ is 0, the first ITAG for a thread₁ (if there is a thread₁) is 64, the first ITAG of a thread₂ (if there is a thread₂) is 128, and the first ITAG of the thread₃ is 192. Readers will realize that in a dual thread mode of operation, the two threads are thread₀ and thread₂ rather than thread₀ and thread₁.

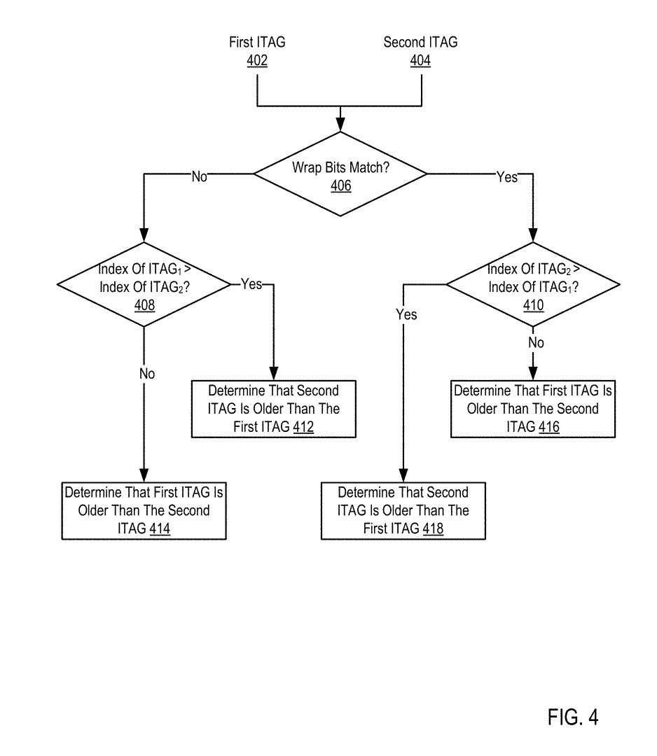

From time to time and for various reason, it may be necessary to determine whether one ITAG is older than another. For example, when a flush occurs, the processor must roll-back to a particular instruction. In such an embodiment, all instructions younger than the particular instruction must be identified. For further explanation therefore, the method of FIG. 4 sets forth a flow chart illustrating an example method of determining whether a first ITAG is older than a second ITAG according to embodiments of the present invention. The method of FIG. 4 may take place after the method of FIG. 3, when at least two ITAGs have been generated for the same thread or two ITAGs have been generated in a single thread mode of operation.

The method of FIG. 4 includes determining (406) whether the wrap bits of the first (402) and second (404) ITAGs match. If the wrap bits match, the method of FIG. 4 continues by determining (408) whether the index of the first ITAG (402) is greater than the index of the second ITAG (404). If the index of the first ITAG (402) is greater than the index of the second ITAG (404), the method of FIG. 4 continues by determining (412) that the second ITAG is older than the first ITAG. Consider, for example, that the first ITAG includes an index of 128 while the second ITAG includes an index of 120. This is indicates, when the wrap bits are equal, that the second ITAG was generated when the counter value was 120 and the first ITAG was generated when the counter value was 128. As the counter increments up, rather than decrements down, a value of 120 represents a younger ITAG than a value of 128. By contrast, if the index of the first ITAG (402) is not greater than the index of the second ITAG (404) (and instead, the reverse is true), the method of FIG. 3 continues by determining (414) that the first ITAG is older than the second ITAG. Readers of skill in the art will recognize that the determination (408) is merely a determination of the greatest index between the first and second ITAGs. When the wrap bits match, the greatest index is younger ITAG.

As mentioned above, when the counter value reaches its maximum and wraps around, the value of the wrap bit is flipped (from 0 to 1 or from 1 to 0). Further, readers will understand that the total number of instructions in flight in the computer processor may be a maximum value. Consider, for example, that the computer processor is restricted to 256 instructions in flight. In such an environment, when the counter wraps around from 255 to 0 and the wrap bit is flipped from 0 to 1, there is not another instruction with the value of 0 as that instruction must have been retired before the new ITAG (having a wrap bit of 1 and index of 0) is generated. As an example, consider that 255 ITAGs were generated with an index of 0 through 255. Prior to the generation of the 256^{th} ITAG, the instruction having an index of 0 and wrap bit of 1 is retired. Upon the 256^{th} instruction, the wrap is flipped from 0 to 1 and the index of the newly generated ITAG is 0. Prior to the next generation of an ITAG, the ITAG having a wrap bit of 0 and an index of 1 is retired. The next ITAG then may have an wrap bit of 1 and an index of 1. In this scenario, all ITAGs currently outstanding that have a wrap bit of 0 will have an index greater than any ITAG having a wrap bit of 1.

To that end, when the wrap bits of the first and second ITAGs do not match, the method of FIG. 4 continues by determining whether the index of the second ITAG (404) is greater than the index of the first ITAG (402). If the index of the second ITAG (404) is greater than the index of the first ITAG (402), the method of FIG. 4 continues by determining (418) that the second ITAG is older than the first ITAG. By contrast, the method of FIG. 4 also includes determining (416) that the first ITAG is older than the second ITAG if the index of the second ITAG is not greater than the index of the first ITAG. Readers of skill in the art will recognize the determination (410) is merely a determination of the greatest index. The ITAG having the greatest index, when wrap bits do not match, is the oldest ITAG.

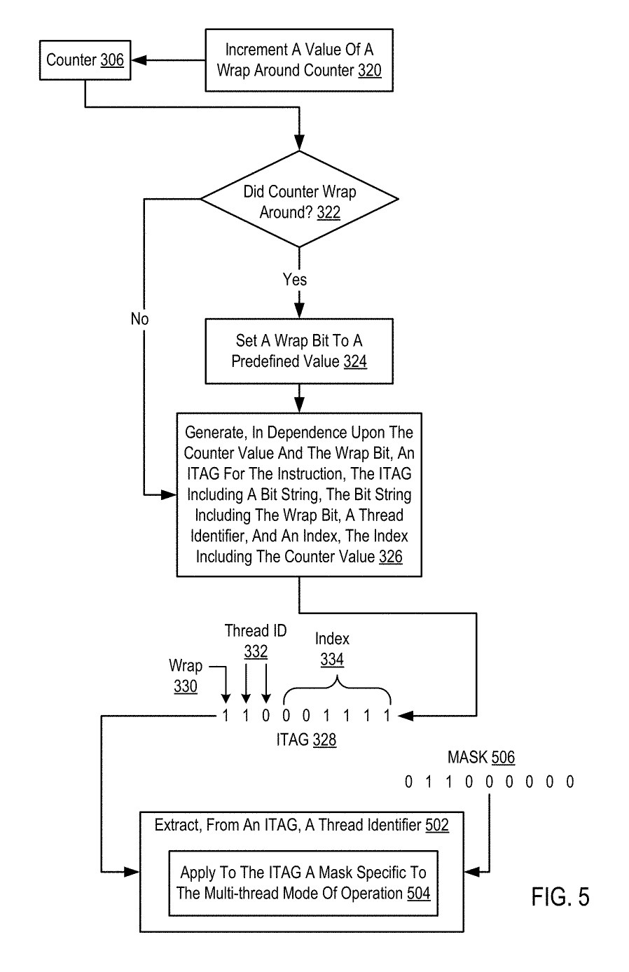

As mentioned above, in a multi-threaded mode of operation, each ITAG may be generated with at thread identifier. For further explanation, FIG. 5 sets forth a flow chart illustrating another example method of administering ITAGs in a computer processor according to embodiments of the present invention. The method of FIG. 5 is similar to the method of FIG. 3, including the steps association with generating an ITAG when in a multi-thread mode of operation.

The method of FIG. 5 also includes extracting (502), from an ITAG (328), a thread identifier (332). In the example of FIG. 5, extracting (502) a thread identifier (332) may be carried out by applying (504) to the ITAG a mask (506) specific to the multi-thread mode of operation. In the example of FIG. 5, the ITAG includes a two-bit thread identifier (332). Such a two-bit thread identifier may be capable of uniquely identifying four threads: 00, 01, 10, 11. Each mask may be specific to multi-threaded mode of operation and be the same length as the ITAG (9-bits, for example). The following are example masks, each associated with a different multi-threaded mode of operation. For dual-threaded mode of operation, the mask may be 010000000, where the thread identifiers for the mode are 0 and 2 (00, and 10). For quad-threaded mode of operation, the mask may be 011000000.

Applying the mask may include performing a bitwise AND operation between the mask and the ITAG. In the example of FIG. 5, the ITAG is, 110001111, the processor is in a quad thread mode of operation, and the mask is 011000000. Performing a bitwise AND operation between the mask and ITAG results in a bit string of 010000000. Bits 1,2 of the bit string represent a thread identifier of 10, that is, a thread ID of 2.

Another bitwise operation that may be performed on an ITAG is the incrementing of an ITAG. For purposes of explanation, the following pseudo-VHDL (Very High Speed Integrated Circuit Hardware Description Language):

itag_smt_mask(0 to 8) <= ‘0’ & smt_mask(0 to 1) & “000000”;
itag_plus1_raw(0 to 8) <= (itag_smt_mask(0 to 8) or itag_q(0 to 8)) +
“000000001”;
itag_plus1(0) <= itag_plus1_raw(0);
itag_plus1(1 to 2) <= ((itag_plus1_raw(1 to 2) and not smt_mask(0 to

1)) or (itag_q(1 to 2) and smt_mask(0 to 1)));

itag_plus1(3 to 8) <= itag_plus1_raw(3 to 8);

In the above pseudo-VHDL, that ‘itag_smt_mask’ is nine bits in length and is assigned the value of: 0 concatenated with an smt_mask of two bits followed by six zeros. As mentioned above, in a single thread mode of operation, the smt_mask is 00, in a dual thread mode of operation, the smt_mask is 10, and in a quad-thread mode the smt_mask is 11. As an example, in a dual thread mode of operation, the itag_smt_mask is 010000000.

The pseudo-VHDL also includes itag_plus1_raw which is nine bits in length and assigned the value of: one plus the value of a bitwise OR of the itag_smt_mask and itag_q, where itag_q is the present value of the ITAG, prior to incrementing the ITAG. The itag_q is nine bits in length, where the first bit is a wrap bit, the second and third bits are the thread identifier if the processor is configured in a multi-thread mode of operation, and the remaining bits are the present index value. Consider, for example, that the itag_q is 010110100 and the processor is configured in a dual-thread mode of operation. In this example, the wrap bit is 0, the thread identifier is a binary 10 (two in decimal), and the index portion represents a decimal value of 52 (binary value of 110100). The bitwise or operation of the itag_q and itag_smt_mask (which in a dual thread is 010000000) results in a bit string of 010110100. Adding one to the bit string results in a value of 010110101. That is, the itag_plus1_raw bit string is 010110101.

The pseudo-VHDL above also includes assigning to the first bit of an itag_plus1 bit string, the first bit of the itag_plus1_raw bit string. In this way, the itag_plus1 bit string includes the wrap bit of the current ITAG value.

The itag_plus1 bit string must take into account the thread identifier, if any, of the current ITAG that is being incremented (itag_q). To do so, the pseudo-VHDL performs a bitwise OR operation on two values. The first value is calculated as a bitwise AND operation between the second and third bits of the itag_plus1_raw bit string (which are 10 in the above example) with the inverse of the smt_mask. The inverse of the smt_mask, continuing with the example above is 01. As such, the bitwise AND of the second and third bits of the itag_plus1_raw bit string and the example smt_mask results in a first value of 00. The second value calculated above is a bitwise AND operation between the second and third bits of the itag_q bit string (10 in the above example) and the smt_mask (10 in the above example). In such an example, the bitwise AND of the second and third bits of the itag_q bit string and the smt_mask results in a second value of 10. Performing a bitwise OR operation between the first and second values above results in a value of 10 which is assigned to the second and third bits of the itag_plus1 bit string.

Finally, the pseudo-VHDL above sets the fourth through ninth bits of the itag_plus1 bit string equal to the fourth through ninth bits of the itag_plus1_raw bit string. The final value of the itag_plus1 bit string is the value of the incremented ITAG. Readers will understand that any thread mode may be implemented and the same calculation above may be utilized to increment the current ITAG value to the next ITAG value while maintaining the correct thread identifier, if any, wrap bit and the incremented index value of the ITAG.

Readers of skill in the art will recognize that the calculations above to take into account a thread identifier can be performed regardless of whether the processor is configured in a single or multi-thread mode of operation. Consider, as another example, that the processor is configured in a single thread mode of operation where the smt_mask is 00. In such an example, where the itag_q (the ITAG that the above pseudo-code is incrementing) remains 010110100, there is no thread identifier and the index is 8 bits in length beginning with the second bit and representing the decimal value of 180. In such an example, the pseudo-code above will perform a bitwise AND operation between the itag_plus1_raw(1 to 2) bits and the inverse of the smt mask. In a single thread mode, the smt_mask value is 00 and, thus, the inverse is 11. The second and third bits of the itag_plus1_raw bit string, as calculated in the second line of pseudo-VHDL above, are 10. To that end, the first value calculated by the pseudo-VHDL is 10 (11 AND 00). The second value calculated is the bitwise AND of the second and third bits of the itag_q bit string (10) and the smt_mask (00 in single thread mode). The second value in this example is 00. The bitwise OR of the first value and the second value results in 10. In this example, a thread identifier is not selected as the second and third bits of the itag_plus1 bit string but rather the value of the index of the incremented ITAG is selected.

Consider another example where the ITAG to be incremented (itag_q) is 001111111. In a single thread mode there is no thread identifier encoded in the bit stream. When performing the VHDL above, the smt_mask is 00 and the ITAG will be incremented to 010000000. By contrast, in a quad thread mode, the ITAG to be incremented is encoded with a thread identifier. In this example, the thread identifier is 01 (thread₁) and the resulting incremented ITAG must also include that thread identifier. To that end, when performing the VHDL above, the smt_mask is 11 and the resulting incremented ITAG is 101000000, where the wrap bit is flipped as the index is wrapped around back to zero.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering instruction tags (ITAGs) in a computer processor, the method comprising:
for each instruction when the computer processor is in a single-thread mode of operation:
incrementing a value of a wrap around counter;
setting a wrap bit to a predefined value if incrementing the value of the wrap around counter causes the counter to wrap around;
generating, in dependence upon the counter value and the wrap bit, an ITAG for the instruction, the ITAG comprising a bit string, the bit string comprising the wrap bit and an index, the index comprising the counter value; and
for each instruction when the computer processor is in a multi-thread mode of operation:
incrementing the value of the wrap around counter;
setting a wrap bit to a predefined value if incrementing the value of the wrap around counter causes the counter to wrap around; and
generating, in dependence upon the counter value and the wrap bit, an ITAG for the instruction, the ITAG comprising a bit string, the bit string comprising the wrap bit, a thread identifier, and an index, the index comprising the counter value.

2. The method of claim 1, wherein:
the computer processor is in a single-thread mode of operation; and
the ITAG comprising a 9-bit long bit string, wherein a first bit comprises the wrap bit and the other 8 bits comprise the index.

3. The method of claim 1, wherein:
the computer processor is in a dual-thread mode of operation; and
the ITAG comprising a 9-bit long bit string, wherein a first bit comprises the wrap bit, a second bit comprises a thread identifier, and the other 7 bits comprise the index.

4. The method of claim 1, wherein:
the computer processor is in a quad-thread mode of operation; and
the ITAG comprising a 9-bit long bit string, wherein a first bit comprises the wrap bit, a second and third bits comprise a thread identifier, and the other 6 bits comprise the index.

5. The method of claim 1 further comprising:
determining, whether a first ITAG is older than a second ITAG including:
determining whether the wrap bits of the first and second ITAGs match;
if the wrap bits match:
determining that the first ITAG is older than the second ITAG if the index of the second ITAG is greater than the index of the first ITAG; and
determining that the second ITAG is older than the first ITAG if the index of the first ITAG is greater than the index of the second ITAG;
if the wrap bits do not match:
determining that the first ITAG is older than the second ITAG if the index of the first ITAG is greater than the index of the second ITAG; and
determining that the second ITAG is older than the first ITAG if the index of the second ITAG is greater than the index of the first ITAG.

6. The method of claim 1 wherein the computer processor is in a multi-thread mode of operation and the method further comprises:
extracting, from an ITAG, a thread identifier including applying to the ITAG a mask specific to the multi-thread mode of operation.

7. The method of claim 1 wherein the computer processor comprises a multi-slice processor, the multi-slice processor comprising a plurality of execution slices and a plurality of load/store slices, wherein the load/store slices are coupled to the execution slices via a results bus.

8. A computer processor for administering instruction tags (ITAGs), the processor configured to carry out:
for each instruction when the computer processor is in a single-thread mode of operation:
incrementing a value of a wrap around counter;
setting a wrap bit to a predefined value if incrementing the value of the wrap around counter causes the counter to wrap around;
generating, in dependence upon the counter value and the wrap bit, an ITAG for the instruction, the ITAG comprising a bit string, the bit string comprising the wrap bit and an index, the index comprising the counter value; and
for each instruction when the computer processor is in a multi-thread mode of operation:
incrementing the value of the wrap around counter;
setting a wrap bit to a predefined value if incrementing the value of the wrap around counter causes the counter to wrap around; and
generating, in dependence upon the counter value and the wrap bit, an ITAG for the instruction, the ITAG comprising a bit string, the bit string comprising the wrap bit, a thread identifier, and an index, the index comprising the counter value.

9. The computer processor of claim 8, wherein:
the computer processor is in a single-thread mode of operation; and
the ITAG comprising a 9-bit long bit string, wherein a first bit comprises the wrap bit and the other 8 bits comprise the index.

10. The computer processor of claim 8, wherein:
the computer processor is in a dual-thread mode of operation; and
the ITAG comprising a 9-bit long bit string, wherein a first bit comprises the wrap bit, a second bit comprises a thread identifier, and the other 7 bits comprise the index.

11. The computer processor of claim 8, wherein:
the computer processor is in a quad-thread mode of operation; and
the ITAG comprising a 9-bit long bit string, wherein a first bit comprises the wrap bit, a second and third bits comprise a thread identifier, and the other 6 bits comprise the index.

12. The computer processor of claim 8 further configured to carry out:
determining, whether a first ITAG is older than a second ITAG including:
determining whether the wrap bits of the first and second ITAGs match;
if the wrap bits match:
determining that the first ITAG is older than the second ITAG if the index of the second ITAG is greater than the index of the first ITAG; and
determining that the second ITAG is older than the first ITAG if the index of the first ITAG is greater than the index of the second ITAG;
if the wrap bits do not match:
determining that the first ITAG is older than the second ITAG if the index of the first ITAG is greater than the index of the second ITAG; and
determining that the second ITAG is older than the first ITAG if the index of the second ITAG is greater than the index of the first ITAG.

13. The computer processor of claim 8 wherein the computer processor is in a multi-thread mode of operation and the computer processor is further configured to carry out:
extracting, from an ITAG, a thread identifier including applying to the ITAG a mask specific to the multi-thread mode of operation.

14. The computer processor of claim 8 wherein the computer processor comprises a multi-slice processor, the multi-slice processor comprising a plurality of execution slices and a plurality of load/store slices, wherein the load/store slices are coupled to the execution slices via a results bus.

15. An apparatus for administering instruction TAGs (ITAGS), the apparatus comprising a computer processor and a computer memory operatively coupled to the computer processor, the computer processor configured to carry out:
for each instruction when the computer processor is in a single-thread mode of operation:
incrementing a value of a wrap around counter;
setting a wrap bit to a predefined value if incrementing the value of the wrap around counter causes the counter to wrap around;
generating, in dependence upon the counter value and the wrap bit, an ITAG for the instruction, the ITAG comprising a bit string, the bit string comprising the wrap bit and an index, the index comprising the counter value; and
for each instruction when the computer processor is in a multi-thread mode of operation:
incrementing the value of the wrap around counter;
setting a wrap bit to a predefined value if incrementing the value of the wrap around counter causes the counter to wrap around; and
generating, in dependence upon the counter value and the wrap bit, an ITAG for the instruction, the ITAG comprising a bit string, the bit string comprising the wrap bit, a thread identifier, and an index, the index comprising the counter value.

16. The apparatus of claim 15, wherein:
the computer processor is in a single-thread mode of operation; and
the ITAG comprising a 9-bit long bit string, wherein a first bit comprises the wrap bit and the other 8 bits comprise the index.

17. The apparatus of claim 15, wherein:
the computer processor is in a dual-thread mode of operation; and
the ITAG comprising a 9-bit long bit string, wherein a first bit comprises the wrap bit, a second bit comprises a thread identifier, and the other 7 bits comprise the index.

18. The apparatus of claim 15, wherein:
the computer processor is in a quad-thread mode of operation; and
the ITAG comprising a 9-bit long bit string, wherein a first bit comprises the wrap bit, a second and third bits comprise a thread identifier, and the other 6 bits comprise the index.

19. The apparatus of claim 15, wherein the computer processor is further configured to carry out:
determining, whether a first ITAG is older than a second ITAG including:
determining whether the wrap bits of the first and second ITAGs match;
if the wrap bits match:
determining that the first ITAG is older than the second ITAG if the index of the second ITAG is greater than the index of the first ITAG; and
determining that the second ITAG is older than the first ITAG if the index of the first ITAG is greater than the index of the second ITAG;
if the wrap bits do not match:
determining that the first ITAG is older than the second ITAG if the index of the first ITAG is greater than the index of the second ITAG; and
determining that the second ITAG is older than the first ITAG if the index of the second ITAG is greater than the index of the first ITAG.

20. The apparatus of claim 15 wherein the computer processor is in a multi-thread mode of operation and the computer processor is further configured to carry out:
extracting, from an ITAG, a thread identifier including applying to the ITAG a mask specific to the multi-thread mode of operation.
